(19) United States
(12) Patent Application Publication
(10) Pub. No.: US 2025/0228369 A1
(43) Pub. Date: Jul. 17, 2025

(54) LOW-PROFILE RECLINING SEATING ASSEMBLY

(71) Applicant: L&P Property Management Company, South Gate, CA (US)

(72) Inventor: Gregory Mark Lawson, Carthage, MO (US)

(21) Appl. No.: 19/024,864

(22) Filed: Jan. 16, 2025

Related U.S. Application Data
(60) Provisional application No. 63/621,379, filed on Jan. 16, 2024.

(51) Int. Cl. A47C 1/0355; B60N 2/02; B60N 2/20; B60N 2/90

(52) U.S. Cl. CPC A47C 1/0355; B60N 2/02246; B60N 2/0226; B60N 2/20; B60N 2/995

(57) ABSTRACT

Disclosed herein is a reclining seating assembly and a reclining seat. The assembly and set include a seat frame and a base frame, configured to connect to the seat frame by a hinge. The assembly and seat include a support frame configured to connect to the base frame, an actuator configured to connect to the support frame and the seat frame, and a pair of linkage mechanisms. Each linkage mechanism has a base plate and a seat plate configured to connect by a plurality of linking arms, the base plate of each linkage mechanism configured to connect to the base frame and the seat plate of each linkage mechanism configured to connect to the seat frame, where the reclining seating assembly is configured to move between a reclined position and a seated position by extension or contraction of the actuator.

### CROSS-REFERENCE TO RELATED APPLICATIONS

This application claims the benefit of priority under 35 U.S.C. § 119 (e) to U.S. Application Ser. No. 63/621,379, filed Jan. 16, 2024, the entire contents of which are incorporated by reference herein.

### FIELD OF THE DISCLOSURE

The disclosure generally relates to reclining furniture, including linkage mechanisms for reclining furniture.

### BACKGROUND

Reclining furniture can support a user's body in both seated and reclined positions. Reclining furniture includes recliners, incliners, sofas, love seats, sectionals, riser recliners, traditional chairs, and chairs with a reclining seat portion. Reclining furniture allows a user to move between the seated and reclined positions, e.g., forward or backward. Reclining furniture can include a footrest extendable in front of the seat. Existing reclining furniture can have one or more actuators to move the reclining furniture between the seated and reclined positions. Linkage mechanisms in reclining furniture allow the footrest to automatically extend from a closed position as the furniture is reclined, but the linkage mechanism is typically bulky.

Riser recliners include a seat base positioned atop an installed riser structure, and can be used in theaters, other settings where seats are arranged in successively elevated rows, and small, multi-functional settings such as RVs. When extended, the footrest can extend into an aisle space in front of the recliner.

### SUMMARY

In general, an aspect disclosed herein is a reclining seating assembly. The assembly includes a seat frame and a base frame, configured to connect to the seat frame by a hinge. The assembly includes a support frame configured to connect to the base frame, an actuator configured to connect to the support frame and the seat frame, and a pair of linkage mechanisms. Each linkage mechanism has a base plate and a seat plate configured to connect by a plurality of linking arms, the base plate of each linkage mechanism configured to connect to the base frame and the seat plate of each linkage mechanism configured to connect to the seat frame, where the reclining seating assembly is configured to move between a reclined position and a seated position by extension or contraction of the actuator.

Examples may include one or more of the following features. Extending the actuator can cause the reclining seat assembly to enter the reclined position in which the linkage mechanism is caused to extend and an angle formed between the seat frame and the base frame increases. Contracting the actuator can cause the reclining seat assembly to enter the seated position in which the linkage mechanism contracts and the angle formed between the seat frame and the base frame decreases. When the reclining seating assembly is in the seated position, the linkage mechanism can be fully contracted. When the linkage mechanism is fully contracted, the linkage mechanism can have a depth of less than or equal to 3 inches. When the reclining seating assembly is in the contracted position, a height of the seat frame and the base frame can be less than or equal to 3 inches. When the reclining seating assembly is in the reclined position, the linkage mechanism can be fully extended. The assembly may include a backrest bracket coupled to the seat frame at the hinge, and a chair back fixedly coupled to the backrest bracket, such that the chair back moves with the seat frame. The assembly may include an ottoman connected to an ottoman plate of the linkage mechanism, the ottoman plate at an opposing end of the linkage mechanism from the base plate, and a seat attached to the seat frame. The assembly may include arms adjacent the reclining seat assembly, and a base frame and support frame fixedly attached to a commercial theater riser. The assembly the base frame and support frame fixedly attached to a recreational vehicle seating riser. The actuator can extend in a direction that can be substantially perpendicular to a plane of the base frame. The actuator can be configured to pivotally connect to a mounting bracket of the base frame and configured to pivotally connect to a mounting bracket of the support frame. The base frame and the support frame can be configured to affix to two perpendicular faces of a riser on which the reclining seat assembly is installed. The linkage mechanism may include a seat plate fixedly coupled to the seat frame. The actuator can be an electric actuator or a pneumatic actuator. In some embodiments, there can be only one actuator. In some embodiments, there can be two actuators, three actuators, or more actuators. The reclining seating assembly may include a backrest frame connected to the base frame, the backrest frame. The reclining seating assembly may include a lower frame pivotally connected to a headrest frame, and a second actuator configured to connect to the lower frame and the headrest frame, where the backrest frame is configured to move between a first position and a second position of the headrest frame by extension or contraction of the second actuator. The first position and the second position may be rotated by an angle preferably between 15 and 20 degrees, an angle less than 20 degrees, or an angle between 15 and 25 degrees, an angle between 15 and 30 degrees. The reclining seating assembly may include a pair of brackets connecting the backrest frame to the base frame, the pair of brackets having a sequence of openings arranged to align with an opening of the lower frame such that the lower frame can be positioned in one position of a plurality of positions. The seat frame may be a folding seat frame and may include a cushion support frame pivotally connected to a lower seat frame. The folding seat frame may be configured such that the cushion support frame pivotally connects to the lower seat frame such that the cushion support frame rotates at least partially around an axis parallel with a front edge of the cushion support frame and a front edge of the lower seat frame. The seat frame may include hinges pivotally connecting the cushion support frame to the lower seat frame. The hinges may be configured to hinge inward of outer dimensions of the seat frame and outer dimensions of the cushion support frame. The seat frame may be configured to form an angle with respect to the base frame when the reclining seating assembly is in the seated position. The angle may be less than 5°. The base frame, the seat frame, or the support frame may include tubular metal components, or angled metal components. The tubular metal components, or angled metal components, may be welded to form the base frame, the seat frame, or the support frame.

In general, an aspect disclosed herein is a reclining seat including a seat frame, and a base frame configured to connect to the seat frame by a hinge. The reclining seat includes a backrest configured to fixedly attach to the seat frame. The reclining seat includes a support frame configured to connect to the base frame, and an actuator configured to pivotally connect to the support frame and the seat frame. The reclining seat includes an ottoman board, two chair arms configured to be arranged on opposing sides of the base frame, and a pair of linkage mechanisms each having a base plate, a seat plate, and an ottoman plate configured to connect by a plurality of linking arms, the base plate of each linkage mechanism configured to connect to the base frame, the seat plate of each linkage mechanism configured to connect to the seat frame, and the ottoman plate configured to connect to the ottoman board, where the reclining seat is configured to move between a reclined position and a seated position by extension or contraction of the actuator. The reclining seat includes a plurality of cushions configured to be installed to at least one of the seat frame, the ottoman board, or the back rest, a user interface configured to be installed in one of the chair arms, and a controller in electronic communication with the user interface and the actuator and configured to receive commands from the user interface and control the actuator in response to the received commands.

Particular implementations of the subject matter described in this specification can be implemented so as to realize one or more of the following technical advantages.

The recliner assembly disclosed herein achieves a low seat height above a riser on which the assembly is installed, and compact linkage area in front of the riser. This reduces the volumetric footprint of the recliner assembly allowing for more area in front of the recliner assembly when in a seated position without reducing the extension of the linkage when reclined.

The recliner assembly disclosed herein can utilize an actuator positioned behind the ottoman board and between the linkage mechanisms to provide the compact profile.

The ottoman position can be controlled by vertical movement of the seat frame with a single-actuator design that reduces complexity as compared to existing designs. The backrest can be fixed to the seat and can recline as the seat tilts, providing a position resembling zero-gravity and increasing user comfort.

The recliner assembly can allow for easy cleaning in commercial theater settings and increases under-seat storage for recreational vehicle (RV) applications.

The recliner assembly disclosed herein can include an actuator positioned in the backrest to provide a controlled headrest angle for an occupant. This configuration increases occupant comfort and configurable positions for different occupants.

The recliner assembly disclosed herein can include a minimum angle between the seat frame and the base frame. The minimum angle reduces areas which can pinch objects thereby increasing safety of the recliner assembly.

The recliner assembly disclosed herein can include a seat frame which unfolds to provide full access to the components of the seat frame. Such a configuration increases access during installation, cleaning, or maintenance lowering labor and time involved in such activities.

The details of one or more embodiments are set forth in the accompanying drawings and the description below. Other features and advantages will be apparent from the description and drawings, and from the claims.

### DESCRIPTION OF DRAWINGS

FIG. 1A is a perspective-view schematic diagram of a riser recliner in a seated state.

FIG. 1B is a perspective-view schematic diagram of the riser recliner of FIG. 1A in a reclined state.

FIG. 1C is a side-view schematic diagram of the riser recliner of FIG. 1A in the seated state.

FIG. 1D is a side-view schematic diagram of the riser recliner of FIG. 1B in the reclined state.

FIG. 2A is a perspective-view schematic diagram of a reclining seating assembly for the riser recliner.

FIG. 2B is a side-view schematic diagram of the reclining seating assembly of FIG. 2A in the seated state.

FIG. 2C is a side-view schematic diagram of the reclining seating assembly of FIG. 2A in the reclined state.

FIGS. 3A and 3B are perspective-view schematic diagrams of a linkage mechanism of the assembly of FIG. 2A in an extended state.

FIGS. 3C and 3D are perspective-view schematic diagrams of the linkage mechanism of the assembly of FIG. 2A in a contracted state.

FIG. 4 is a perspective-view image of an example recliner chair installed to a riser.

FIG. 5A is a perspective-view schematic diagram of a riser recliner in a seated state.

FIG. 5B is a perspective-view schematic diagram of the riser recliner of FIG. 5A in a reclined state.

FIG. 5C is a side-view schematic diagram of the riser recliner of FIG. 5A in the seated state.

FIG. 5D is a side-view schematic diagram of the riser recliner of FIG. 5B in the reclined state.

FIG. 6A is a perspective-view schematic diagram of a reclining seating assembly for the riser recliner.

FIG. 6B is a side-view schematic diagram of the reclining seating assembly of FIG. 6A in the seated state.

FIG. 6C is a side-view schematic diagram of the reclining seating assembly of FIG. 6A in the reclined state.

FIGS. 7A and 7B are perspective-view schematic diagrams of a linkage mechanism of the assembly of FIG. 6A in an extended state.

FIGS. 7C and 7D are perspective-view schematic diagrams of the linkage mechanism of the assembly of FIG. 6A in a contracted state.

FIG. 8 is a perspective-view image of the recliner assembly of FIG. 6A in an unfolded position.

FIG. 9 is a side-view schematic diagram of a base frame and a support frame of an example reclining seating assembly.

In the figures, like references indicate like elements.

### DETAILED DESCRIPTION

Disclosed herein is a low profile, single motor recliner assembly usable in reclining furniture. In some embodiments, the recliner assembly is configured to mount directly to a riser in commercial theater applications. In some embodiments, the recliner assembly is mountable in recreational vehicles (RVs) as a slide-out riser or a storage riser. The actuator of the recliner assembly is placed behind the footrest board to allow for a low and compact seating area.

Throughout the specification, the disclosure of measurable values should be understood to encompass not only the disclosed value itself but also values within 10% of the disclosed value. For example, in this specification, disclosure of 100 cycles encompasses a range of 90-110 cycles unless a narrower range is otherwise specified.

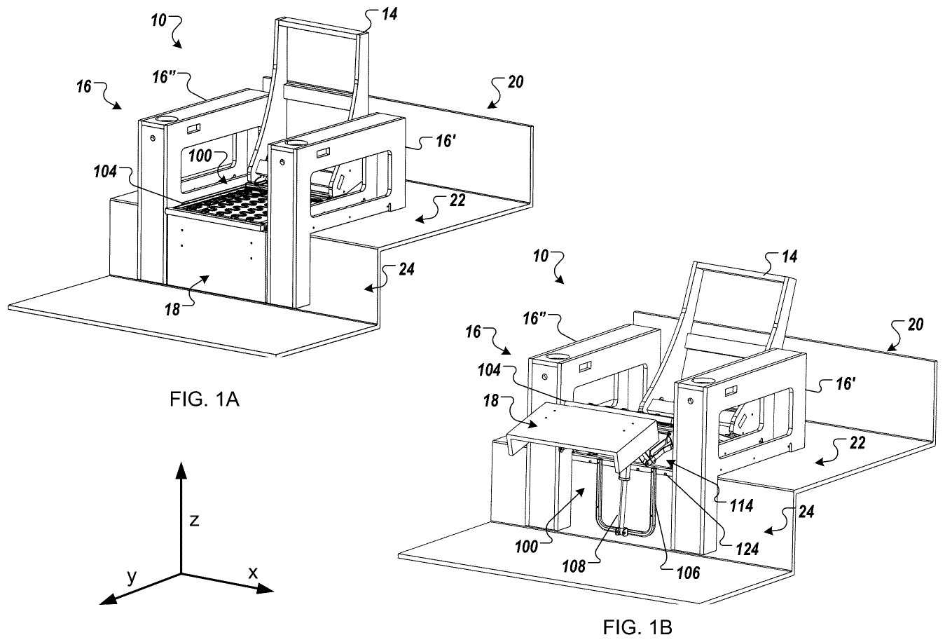

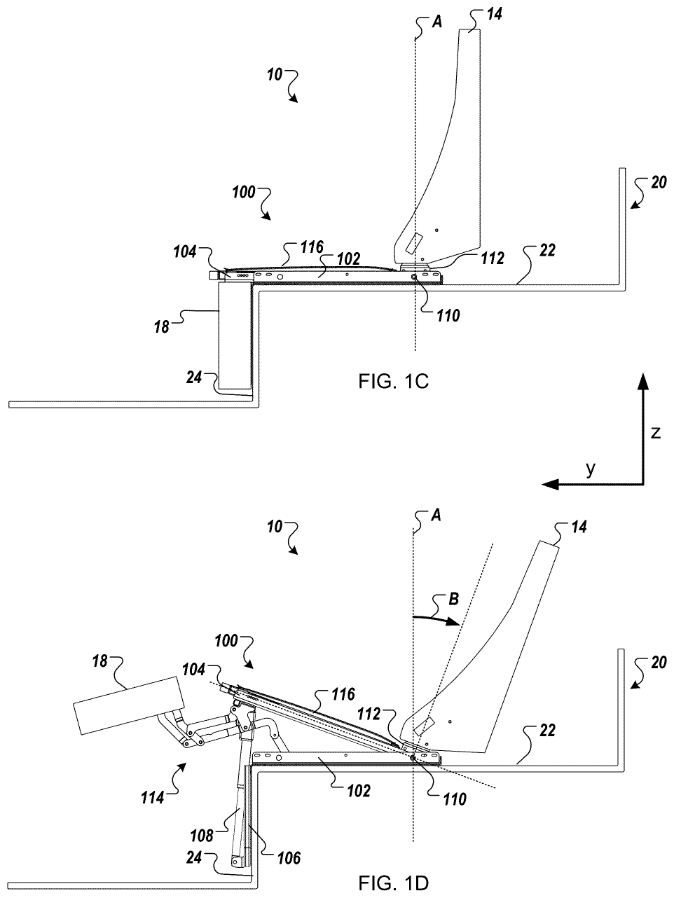

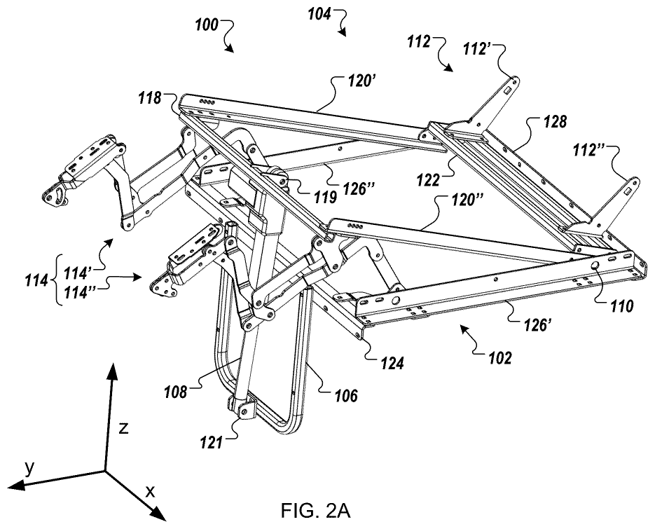

Perspective views of a riser recliner 10 for use in commercial theater settings is shown in FIGS. 1A-1D. The riser recliner 10 is shown installed on a commercial theater riser 20 to support a user in a seated position (FIG. 1A) and a reclined position (FIG. 1B). The riser recliner 10 is installed on the riser 20 which is a common example of a theater-style seating riser installed in theaters. The riser recliner 10 achieves a low seat height upward from the upper riser 22 and a shallow depth forward from the riser face 24, thereby conserving space in front of the ottoman 18 when in the seated position compared to traditional riser recliners. This can be particularly beneficial when space is limited in front of the recliner 10, such as narrow aisle spaces in a movie theater.

A perspective axis is shown inset to FIGS. 1A-D for directional orientation. As used herein, dimensions along the z-direction are referred to as “height,” dimensions along the y-direction are referred to as “depth,” and dimensions along the x-direction are referred to as “width.” As used herein, terms such as “upward,” “upper,” or “above” will be taken to mean along the positive z-direction perpendicular to the upper riser 22, and terms such as “downward,” “below,” or “lower,” will be taken to mean the negative z-direction. Terms such as “forward” will be taken to mean along the positive y-direction, “rearward” will be taken to mean the negative y-direction. In one example, the ottoman 18 extends forward and upward from the seated position to the reclined position.

The riser recliner 10 includes various structures to comfortably support the user. For example, the riser recliner 10 includes a backrest 14, stationary arms 16 (referring collectively to arm 16′ and arm 16″), and an ottoman 18. The arms 16 support the arms of the user in the reclined and seated positions and can include various accessories such as controllers, drink holders, or other features that may be of convenience to the user during use of the riser recliner 10. The backrest 14 supports the torso of the user, particularly in the reclined position, and the ottoman 18 supports the feet and/or legs of the user when the riser recliner 10 is in the reclined position. In general, the riser recliner 10 includes padding and additional coverings for the comfort of the user, although these are not shown in the figures so that the underlying structures of the recliner 10 can be better depicted.

The riser recliner 10 is shown installed on a theater riser 20, which can be an example of a movie theater riser in a commercial or home setting. The riser 20 includes an upper riser 22 onto which the reclining assembly 100 of the riser recliner 10 is installed (e.g., fixedly attached). The riser recliner 10 is arranged on the upper riser 22 such that the backrest 14 can undergo a full range of motion without contacting the riser 20.

The backrest 14 and ottoman 18 are fixedly attached to a reclining seating assembly 100 such that motion of the assembly 100 moves the backrest 14 and ottoman 18 between the seated and reclined positions. The assembly 100 includes a powered actuator 108, such as an electric motor, having a shaft that extends or contracts from a body of the actuator 108 to move the assembly 100 between seated and reclined positions. In some embodiments, the actuator 108 is controlled responsive to signals initiated by a user interacting with one or more user interface controls embedded in either or both of the arms 16. The actuator 108 is controllable such that the assembly 100 moves continuously and smoothly between the seated and reclined positions.

The assembly 100 includes a u-shaped support frame 106 installed to the riser face 24 and an actuator 108 having a distal end hingedly attached to the support frame 106. The support frame 106 is attached to a front bracket 124 of the assembly 100, the front bracket 124 being attached to the riser 20 at the riser face 24, the upper riser 22, or both.

When activated, a shaft of the actuator 108 extends to increase its length along a longitudinal axis of the actuator 108. The shaft extension imposes a force between the support frame 106 and a hinged seat frame 104, thereby causing the riser recliner 10 to move between the reclined and seated positions by lifting a front edge of the seat frame 104 with respect to the lower edge of the support frame 106. In some implementations, the assembly 100 beneficially includes just a single actuator 108 to move the assembly 100 between the seated and reclined positions. The assembly 100 including only one actuator 108 can reduce complexity of construction, reduce maintenance, and reduce power consumption of the riser recliner 10 as compared to designs that rely on multiple actuators. Examples of the actuator 108 include a pneumatic or electric piston.

Side views of the riser recliner 10 and riser 20 and the perspective axes are shown in FIGS. 1C and 1D. The arms 16 are not shown in FIGS. 1C and 1D to provide additional views of the assembly 100 and installation to the riser 20. FIG. 1C shows a side view of the seated position of FIG. 1A and FIG. 1D shows a side view of the reclined position of FIG. 1B.

The assembly 100 includes a base frame 102 fixedly installed to the upper riser 22. The front bracket 124 of the base frame 102 is installed parallel with the edge of the riser 20 at which the upper riser 22 meets the riser face 24. The seat frame 104 is pivotally connected to the base frame 102 by a pivoting joint 110. The seat frame 104 includes a seat spring 116 that can support a cushion (not shown) to provide support and comfort for the user in both the seated and reclined positions.

The actuator 108 (hidden by ottoman 18 in FIG. 1C) is connected to the support frame 106 at a point that is lowest on the support frame 106 along the riser face 24. The actuator 108 is attached to a lower edge of the support frame 106 and a forward edge of the seat frame 104 such that the actuator 108 can undergo small angles of rotation during motion between the seated and reclined positions. From the seated position (FIG. 1C), the actuator 108 extends and pushes against the support frame 106 and seat frame 104 to which the actuator 108 is moveably attached, e.g., via a pin (e.g., a Clevis pin), or bearing.

The support frame 106 is fixed to the riser face 24 and the forward edge of the seat frame 104 is moved upward as the actuator 108 extends, rotating the rearward edge of the seat frame 104 around the joint 110 (e.g., around the axis of rotation defined by the hinger, e.g., the x-axis). The backrest 14 is attached to the backrest brackets 112 which are attached to the seat frame 104. Therefore, as the seat frame 104 rotates, the motion is coupled to the backrest 14.

An example reference line, A, is shown in FIGS. 1C and 1D perpendicular to the upper riser 22. When in the seated state, the base frame 102 and seat frame 104 are substantially parallel with the plane of the upper riser 22 and perpendicular to the reference line and/or the riser face 24. The sides of the seat frame 104 are within the sides of the base frame 102 to provide a compact height above the upper riser 22. As the actuator 108 causes the seat frame 104 to rotate about the joint 110, e.g., as the actuator 108 causes the riser recliner 10 to move between the seated and reclined states, the backrest 14 reclines by an angle, B. The backrest 14 is fixed to the seat frame 104 by the bracket 112 so that the angle, B, the backrest 14 reclines is the same angle the seat frame 104 rotates with respect to the base frame 102 and upper riser 22. In some embodiments, the angle, B, is in a range between 0 degrees (e.g., aligned with the upper riser 22 and base frame 102) to 25 degrees (e.g., 0 to 20 degrees, or 0 to 15 degrees).

The motion of the seat frame 104 is coupled to motion of two linkage mechanisms 114 which controls the position of the ottoman 18. As the seat frame 104 moves between the seated and reclined positions, the linkage mechanisms 114 moves between a contracted state (FIG. 1C) and an extended state (FIG. 1D). In the contracted state, the linkage mechanisms 114 define a space between the linkage mechanisms 114 in front of the riser face 24 in which the actuator 108 is arranged thus achieving an efficient use of space compared to traditional under-seat actuator 108 arrangement. In FIG. 1C, the linkage mechanisms 114 and actuator 108 are arranged between the ottoman 18 and the riser face 24. In the extended state, the linkage mechanisms 114 moves the ottoman 18 upward and forward until the ottoman 18 is positioned above the base frame 102, e.g., above the upper riser 22. The motion between the linkage mechanisms 114 and the seat frame 104 is continuously coupled, e.g., the motion is fluid and unhindered.

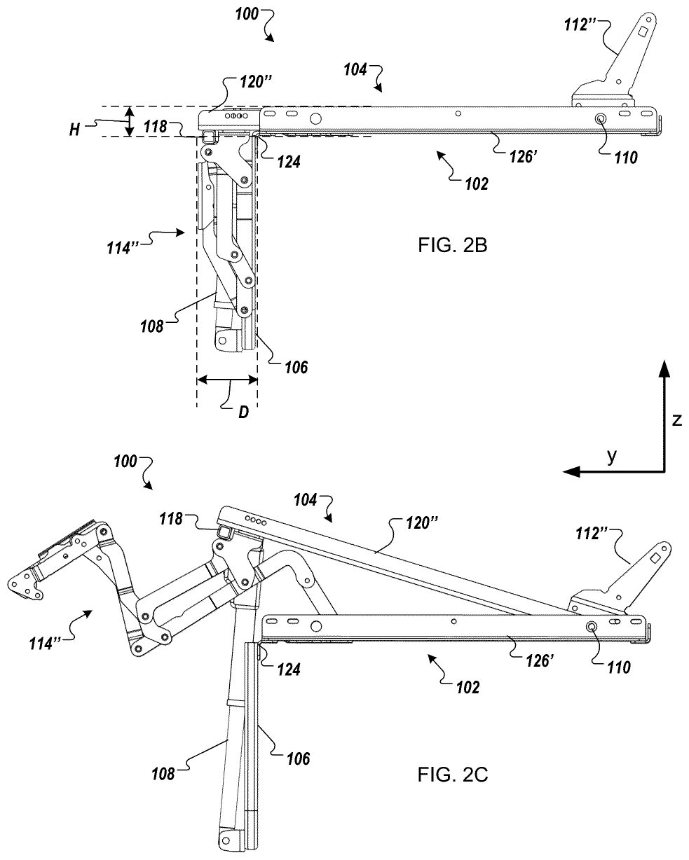

A perspective view of the assembly 100 is shown in FIG. 2A. The seat frame 104 includes side brackets 120, including both side bracket 120′ and side bracket 120″, attached to a front bar 118. The bar 118 is attached to the side brackets 120 at an end opposing the joint 110, e.g., the forward end of the side brackets 120. In this example, the front bar 118 is a closed-cross section ‘tube’ bar which has increased resistance to twisting forces.

The actuator 108 is pivotally attached to a mounting bracket 119 which is fixedly attached to the bar 118. The actuator 108 is pivotally attached to a second mounting bracket 121 which is fixedly attached to the support frame 106. The pivotal connections between the actuator 108 and the mounting brackets 119 and 121 can be implemented with any suitable rotatable connector, e.g., a pin, or a bearing. As the actuator 108 undergoes extension and contraction, the connections between the actuator 108 and the mounting brackets 119 and 121 pivot such that the actuator 108 can undergo small changes in angle which facilitate changes in recline angle between the base frame 102 and the seat frame 104.

The mounting bracket 121 is attached to a front face of the support frame 106 and the mounting bracket 119 is attached to a rear face of the front bar 118. The bracket 119 being attached to a rear face of the bar 118 positions the attached end of the actuator 108 behind the bar 118 which facilitates a shallow forward depth of the reclining assembly 100 when in a seated position.

The base frame 102 includes a front bracket 124 attached to the forward ends of the base brackets 126 (collectively base bracket 126′ and base bracket 126″) and a rear bracket 128 attached to the rearward ends of the base brackets 126. In non-limiting embodiments, the front bracket 124 is attached to and positioned on the edge of the riser face 24 and/or the upper riser 22. The support frame 106 is attached to the front bracket 124, the riser face 24, or both.

Side views of the assembly 100 are shown in FIGS. 2B (seated) and 2C (reclined). The assembly 100 achieves a low seat height, H, and a shallow depth, D. The seat height is the maximum distance between a lowest most portion of the base frame 102 and an upper most portion of the seat frame 104. The assembly 100 preferably has a height that can be less than 3 inches. In some embodiments the assembly 100 has a height that is less than 2 inches. The low height is achieved at least in part by the use of angle brackets for the side brackets 120 which can nest together and provide low vertical clearance.

The linkage mechanisms 114 achieve a low-profile having a shallow depth, D, of 4 inches or less. In some embodiments, the linkage mechanisms 114 achieve a depth of 3 inches or less.

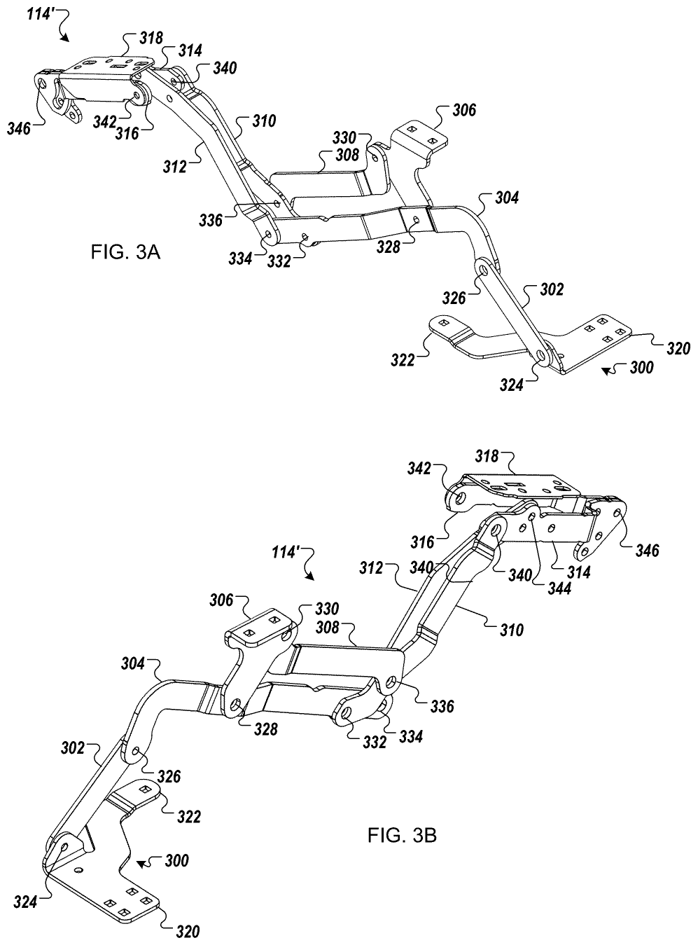

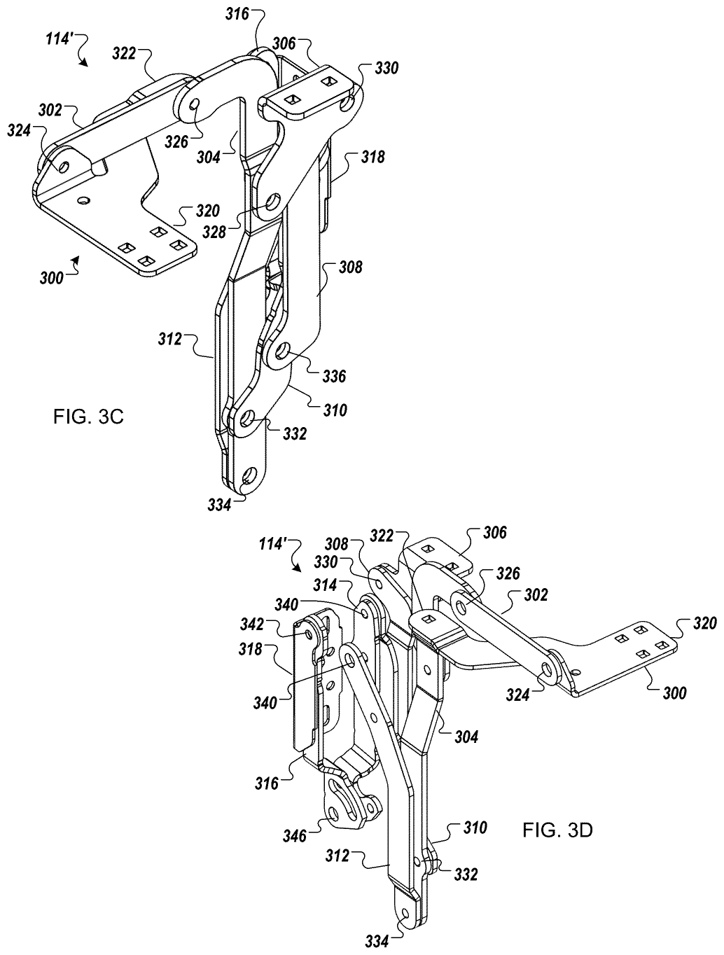

In general, the linkage mechanisms 114, e.g., linkage mechanisms 114′ and 114″, are substantially the same, e.g., have the same components and movement, and are mirror symmetric, e.g., mirror symmetry through the y-z plane. Referring to FIGS. 3A and 3B, perspective views of linkage mechanism 114′ are shown though it is to be understood that the elements and motions described with respect to linkage mechanism 114′ are included in linkage mechanism 114″.

The linkage mechanism 114′ includes a base plate 300 which is affixed to one of the base brackets 126 and the front bracket 124 providing a rigid base to which the extension motions of the linkage mechanisms 114 pivots. In some embodiments, the base plate 300 is affixed to the base brackets 126, the upper riser 22, or both the upper riser 22 and the base brackets 126. The base plate 300 is connected to the base brackets 126 at a base attachment plate 320. The base plate 300 also includes a front attachment plate 322 that connects to the front bracket 124.

The linking arm 302 connects the base plate 300 to the corner arm 304 through two pivot connections 324 and 326. In general, the pivot connections of the linkage mechanisms 114 are rotary connections that allow two components to rotationally swivel around an axis perpendicular to the center of the pivot connection.

The corner arm 304 is generally ‘L’ shaped to facilitate the linkage bending around the front bracket 124 of the base frame 102. The corner arm 304 is connected to the seat plate 306 via pivot connection 328. The seat plate 306 is fixedly connected to the side brackets 120 of the seat frame 104 such that motion of the seat frame 104 is translated into motion of the linkage mechanisms 114 by moving the relative positions of the seat plate 306 and base plate 300. As the actuator 108 extends and moves the seat frame 104 upward, the relative distance between the seat plate 306 and the base plate 300 increases into the extended configuration. The linking arm 302 rotates around pivot connections 324 and is connected to the corner arm 304 at pivot connection 326 such that moving the seat frame causes the corner arm 304 to rotate upward.

Rotation of the corner arm 304 upward urges linking arm 312 and linking arm 310 upward. The linking arm 308 urges the linking arm 310 outward by pressing against the pivot connection 336. As the linking arm 310 rotates around the pivot connection 332 and the pivot connection 336, the linking arm 314 and support arm 316 extend forward. The linking arm 312 rotates around pivot connection 344 thereby extending the linking arm 314 forward and adjusting the respective angle of the ottoman plate 318, such as with respect to the ground, or to the riser face 24.

The seat plate 306 is connected to linking arm 308 via pivot connection 330. The linking arm 308 is connected to linking arm 310 via pivot connection 336. The corner arm 304 is connected to the linking arm 310 and the linking arm 312 via pivot connection 332 and pivot connection 334 respectively. The linking arm 308, corner arm 304, linking arm 310, and linking arm 312 form a four-arm linkage assembly which control the extension and angle of the ottoman plate 318.

The linking arm 312 and the linking arm 310 are connected to linking arm 314 at pivot connection 344 and pivot connection 340 respectively. An ottoman plate 318 is connected to support arm 316 at pivot connection 342 which is connected to linking arm 314 at pivot connection 346. FIGS. 3C and 3D show perspective views of the linkage mechanism 114′ in the collapsed state of FIGS. 1A and 2B.

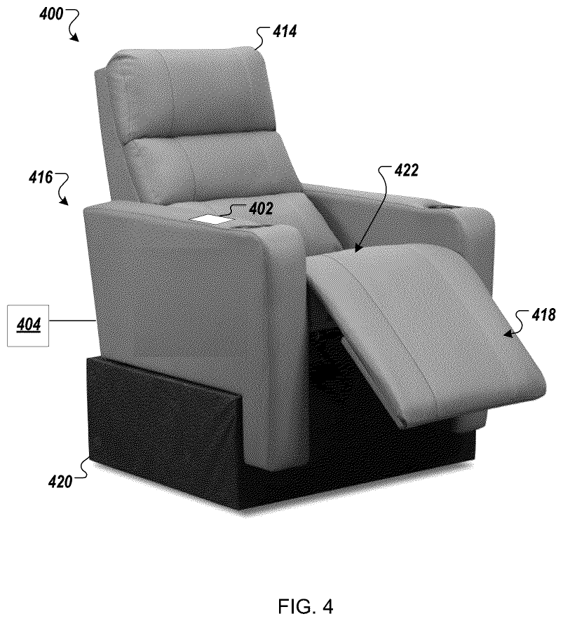

The recliner 10 described herein can include additional components for a user including cushioning and user controls. The cushioning can include any cladding, protective covering, pillowing, or stitching to function as a recliner 10. A reclining chair 400 utilizing the reclining assembly 100 described herein and including a cushioned backrest 414, cushioned arms 416, a cushioned ottoman 418, and a cushioned seat 422 is shown in FIG. 4. The reclining chair 400 is shown in a reclined position and installed to an example riser 420.

The right arm 416 includes a user interface 402 from which a user operates the reclining chair 400. The interface 402 includes user controls, such as buttons, dials, or pads, which control one or more functions of the reclining chair 400. In one non-limiting example, the interface 402 includes controls to actuate the reclining chair 400 into or between the seated and reclined positions.

The reclining chair 400 is shown connected to a controller 404 which is in electronic communication with the user interface 402. Commands input into the interface 402 by the user are received by the controller 404 which operates the reclining chair 400 according to the received commands. For example, commands to change the reclining state of the chair 400 are received by the controller 404 which sends a command to an actuator (not shown in FIG. 4 but can be an example of actuator 108) to change the position of the chair 400.

For example, the controller 404 includes a processor, a memory, a storage device, and one or more input/output interface devices for receiving commands from the user and storing instructions to execute responsive to the received commands. Each of the components can be interconnected, for example, using a system bus.

The processor is capable of processing instructions for execution within the system. The processor is capable of processing instructions stored in the memory or on the storage device. The memory stores information within the system. In some implementations, the memory is a computer-readable medium. The storage device is capable of providing mass storage for the system. In some implementations, the storage device is a non-transitory computer-readable medium. The input/output interface devices provide input/output operations for the system. In some implementations, the input/output interface devices can include one or more of a network interface device, e.g., an Ethernet interface, and/or a wireless interface device, e.g., an 802.11 interface.

In some embodiments, the riser recliners and seating assemblies disclosed in this specification have a higher seat pitch than the embodiments depicted in FIGS. 1-5, and can further include tubular welded components, provide increased weight capacity, and/or provide for increased case of disassembly and repair.

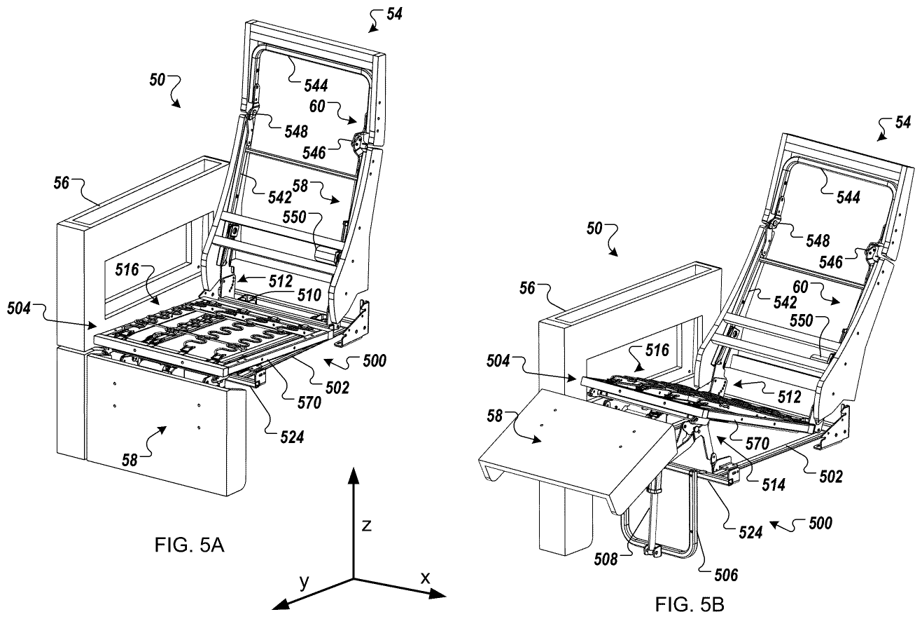

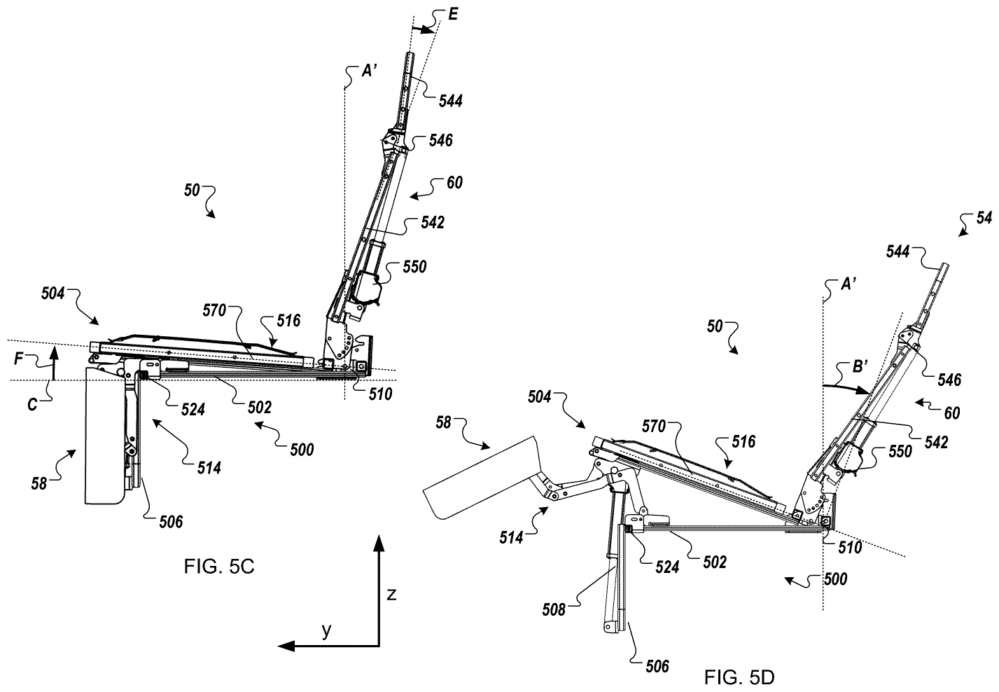

Perspective views of a riser recliner 50 for use in commercial theater applications are depicted in FIGS. 5A-5D. The recliner 50 performs similar functions as the riser recliner 10 described above. The recliner 50 includes another embodiment of the linkage mechanisms which provide benefits and functionality as the linkage mechanisms 114 of the riser recliner 10. The riser recliner 50 is shown arranged to support a user in a seated position (FIG. 5A) and a reclined position (FIG. 5B). A perspective axis is shown inset to FIGS. 5A-D for directional orientation. A commercial riser is not shown in FIGS. 5A-5D, though the recliner 50 may be installed in any configuration that the riser recliner 10 may be installed.

The riser recliner 50 includes a backrest 54 and an ottoman 58 to comfortably support a user between the seated and the reclined positions. The recliner 50 is shown with one stationary arm 56, a second arm is not shown for clarity. The backrest 54 supports the torso of the user, particularly in the reclined position, and the ottoman 58 supports the feet and/or legs of the user when the riser recliner 50 is in the reclined position. In general, the riser recliner 50 may include padding and additional coverings for the comfort of the user.

The backrest 54 and ottoman 58 are fixedly attached to a reclining seating assembly 500 such that motion of the assembly 500 moves the backrest 54 and ottoman 58 into or between the seated and reclined positions. The assembly 500 includes a powered actuator 508 to move the assembly 500 between seated and reclined positions. The actuator 508 is controllable such that the assembly 500 moves continuously and smoothly between the seated and reclined positions.

The assembly 500 includes a support frame 506. One end of the actuator 508 is hingedly attached to the support frame 506. The support frame 506 is attached to a front bracket 524 of the assembly 500, the front bracket 524 being attached to the riser 20 at the riser face 24, the upper riser 22, or both.

The actuator 508 extends between the support frame 506 and a seat frame 504, thereby causing the riser recliner 50 to move between the reclined and seated positions. In some implementations, the assembly 500 includes a single actuator 508 to move the assembly 500 between the seated and reclined positions. Examples of the actuator 508 include those described with respect to the actuator 108 above.

The backrest 54 includes a backrest frame 60 to which additional structural elements are installed. The backrest 54 includes an actuator 550 for controlling, e.g., continuously controlling, an angle, E, between a lower frame 542 and a headrest frame 544. The headrest frame 544 is pivotally connected to an end of the actuator 508. The headrest frame 544 and the lower frame 542 are pivotally connected by hinge 546.

The angle E can be controlled to provide a comfortable head resting angle for an occupant supported by the recliner 50. The angle E can be controlled by the actuator 550 either independently, or concurrently, with the actuator 508 controlling the reclining seating assembly 500 position. The actuator 550 can be controlled by electronic communication, e.g., such as by instructions received from a user interface, e.g., user interface 402, or by instructions stored in a controller of the recliner 50.

Actuation of the actuator 550 controls angle E. The actuator 550 can be controlled to adjust angle E in a range from 0° to 20° forward of the lower frame 542. In some embodiments, the angle E can be in a range from 15° to 20°, from 15° to 30°, from 10° to 20°, or from 15° to 25°.

The backrest frame 60 is hingedly connected to the reclining seating assembly 500 via brackets 512. The brackets 512 include an arcuate sequence of positioning holes through which anchors can be inserted to modularly control a fixed angle by which the backrest frame 60 reclines with respect to the seat frame 504. In this manner, the fixed angle between the backrest frame 60 and the seat frame 504 can be determined at installation of the recliner 50 to a theater riser, or changed after installation.

Side views of the riser recliner 50 and perspective axes are shown in FIGS. 5C and 5D. FIG. 5C shows a side view of the seated position of FIG. 5A and FIG. 5D shows a side view of the reclined position of FIG. 5B.

The assembly 500 includes a base frame 502 which can be installed to a theater riser. The front bracket 524 of the base frame 502 is installed parallel with a forward edge of the riser at which the upper riser meets the riser face, as described above. The seat frame 504 is pivotally connected to the base frame 502 by pivoting joints 510. The seat frame 504 includes a cushion support frame 570 that can support a cushion (not shown) with a set of seat springs 516. The joints 510 are pivoting hinges which using pin connectors, e.g., a clevis pin and cotter pin, in assembly. Using pin connectors in the joints 510 reduces assembly labor when assembling the recliner 50 compared to nuts and bolts. The pin connector joints 510 facilitate installation of the recliner 50 while the arms 56 are installed to the reclining seating assembly 500.

The actuator 508 is connected to a lower edge of the support frame 506 and a forward edge of the seat frame 504. The connections are configured so the actuator 508 can undergo minor rotation during actuation between the seated and reclined positions. The seat frame 504 is configured to be further forward with respect to the base frame 502 compared to the seat frame 104 and the base frame 102 of the reclining seating assembly 100 above. The seat frame 504 being further forward allows for a larger actuator 508 to fit between the riser and ottoman 58. Larger actuators can in some instances provide increased power or actuation speed compared to smaller actuators. Larger actuators can provide increased weight capacity of the recliner 50 and faster speed between seated and reclined positions.

From the seated position (FIG. 5C), the actuator 508 extends and pushes the support frame 506 and seat frame 504 apart. The seat frame 504 is rotated upward as the actuator 508 extends, rotating the seat frame 504 around the joint 510 (e.g., around the x-axis). The backrest 54 is attached to the backrest brackets 512 which are attached to the seat frame 504. Therefore, as the seat frame 504 rotates, the motion is coupled to the backrest 54.

The reference line, A′, is shown in FIGS. 5C and 5D perpendicular to a surface of the riser on which the recliner 50 can be installed, e.g., similar to reference line A of FIGS. 1C and 1D. The reclining seating assembly 500 is configured such that when in the seated state, the base frame 502 and seat frame 504 form an angle, D, with respect to the plane of the surface of the riser on which the recliner 50 can be installed. The angle, D, can be less than 30°, less than 20°, between 10° and 20°, between 15° and 20°, between 10° and 20°, between 20° and 30°, less than 10°, less than 8°, in a range from 3° to 5°, 4°).

The seat frame 504 forming the angle, F, with respect to the base frame 502 provides comfort for the user and can reduce a tendency of the occupant to slide forward on the seat cushions when leaning against the back rest. The arrangement of the seat frame 504 and the base frame 502 allows the reclining seating assembly 500 to have a depth e.g., in the y-direction, that is smaller than the seating assembly 100 above. This allows the reclining seating assembly 500 to be installed on risers having smaller depths. The seat frame 504 forming angle F with respect to the base frame 502 increases safety by reducing areas which may compress, e.g., pinch, objects between the seat frame 504 and base frame 502 during movement of the reclining seating assembly 500.

The actuator 508 is configured to cause the seat frame 504 to rotate about the joint 510 and cause the backrest 54 to reclines by an angle, B′, similar to the actuator 108 above. In some embodiments, the angle, B′, is in a range between 0 degrees (e.g., aligned with the upper riser 22 and base frame 502) to 25 degrees (e.g., 0 to 20 degrees, or 0 to 15 degrees).

The motion of the seat frame 504 is coupled to the linkage mechanisms 514 which control the position of the ottoman 58. As the seat frame 504 moves between the seated and reclined positions, the linkage mechanisms 514 moves between a contracted state (FIG. 5C) and an extended state (FIG. 5D). In the contracted state, the linkage mechanisms 514 are arranged to achieve the efficient use of space as the riser recliner 10 above. In the extended state, the linkage mechanisms 514 moves the ottoman 58 upward and forward into a reclined position. The motion between the linkage mechanisms 514 and the seat frame 504 is continuously coupled.

Elements of the reclining seating assembly 500 and the backrest frame 60 use tubular structural components which are welded. For example, the seat frame 504, the support frame 506, the lower frame 542, and the headrest frame 544 can be welded tubular metal, e.g., steel. The welded tubular metal increases rigidity of the recliner 50. In an example, the welded tubular seat frame 504 reduces twisting if the weight distribution of an occupant is not centered in the seat.

Components of the reclining seating assembly 500 and the backrest frame 60 using tubular metal allows use of self-tapping fasteners, e.g., screws or bolts, for assembly. This facilitates replacement of individual components with the base frame 504 being attached to the riser, with the arms 56 still attached to the base frame 504, or both.

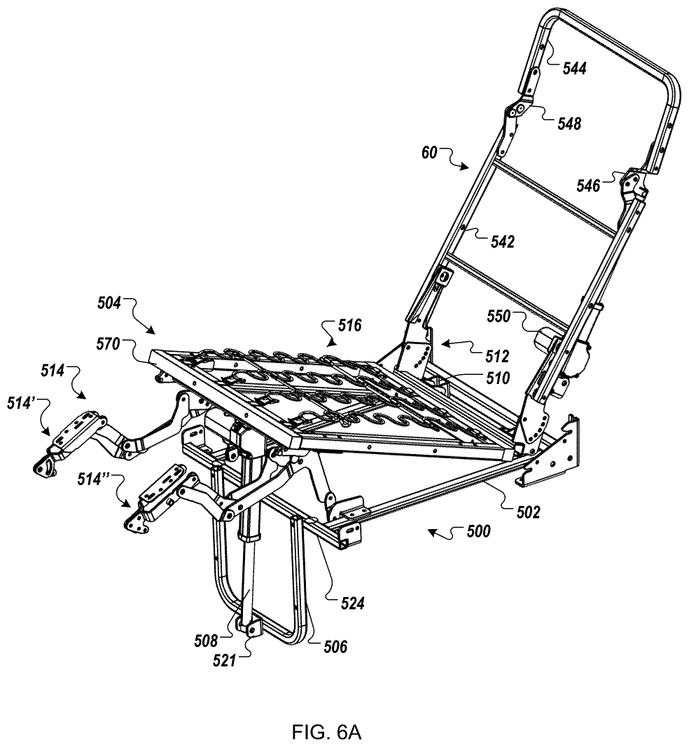

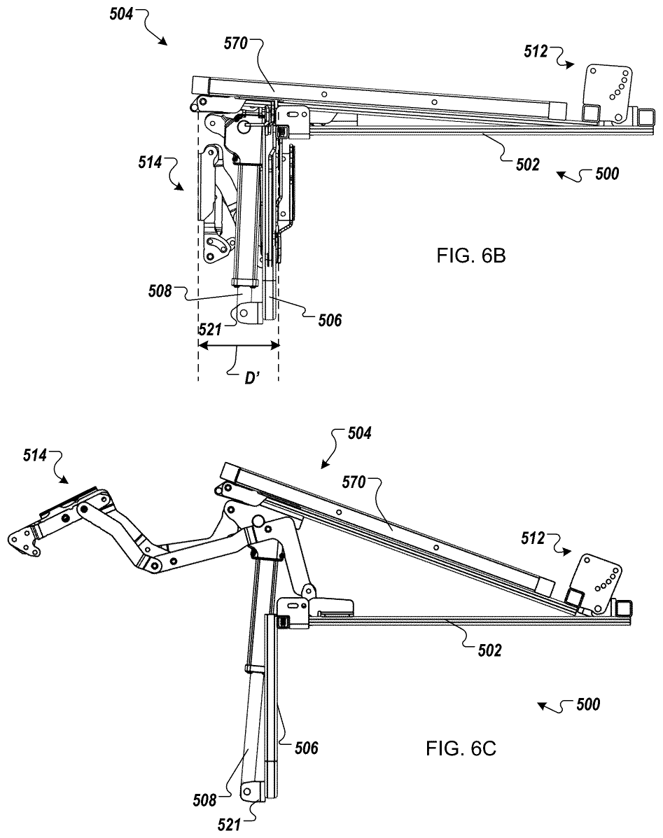

A perspective view of the assembly 500 is shown in FIG. 6A. The actuator 508 is pivotally attached to a mounting bracket which is fixedly attached to the seat frame 504. The actuator 508 is pivotally attached to a second mounting bracket 521 which is fixedly attached to the support frame 506. The pivotal connections between the actuator 508 and the mounting brackets can be implemented with any suitable rotatable connector, e.g., a pin, or a bearing.

The actuator 508 being pivotally attached to a rear face of the front of the seat frame 504 positions the attached end of the actuator 508 behind the front of the seat frame 504. This positioning facilitates the shallow forward depth of the reclining assembly 500 as in the reclining seating assembly 100 above.

In non-limiting embodiments, the front bracket 524 of the base frame 502 is attached to and positioned on the forward edge of the riser face and/or the upper riser. The support frame 506 is attached to the front bracket 524, the riser face, or both.

Side views of the assembly 500 are shown in FIGS. 6B (seated) and 6C (reclined). The linkage mechanisms 514 of the assembly 500 achieves a depth, D′, from the riser face which provides for a larger actuator 508 while maintaining relatively shallow depth from the riser face. The linkage mechanisms 514 achieve depth D′ of 6 inches or less, 5 inches or less. In some embodiments, the linkage mechanisms 514 achieve a depth of 4 inches or less. In some embodiments, the linkage mechanisms 514 achieve a depth between 6 inches and 1 inch, between 6 inches and 2 inches, between 6 inches and 3 inches, between 6 inches and 4 inches, or between 5 inches and 4 inches.

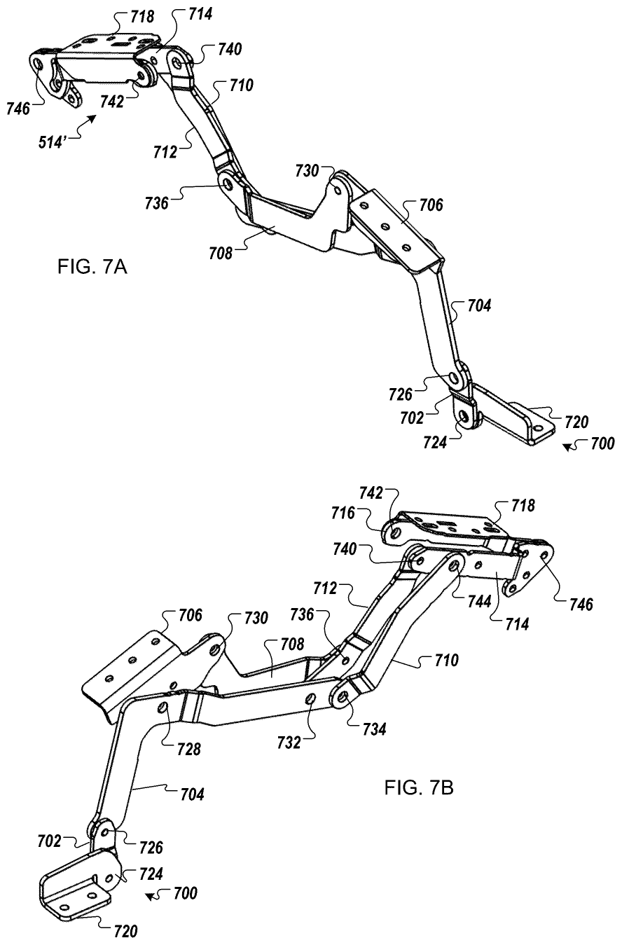

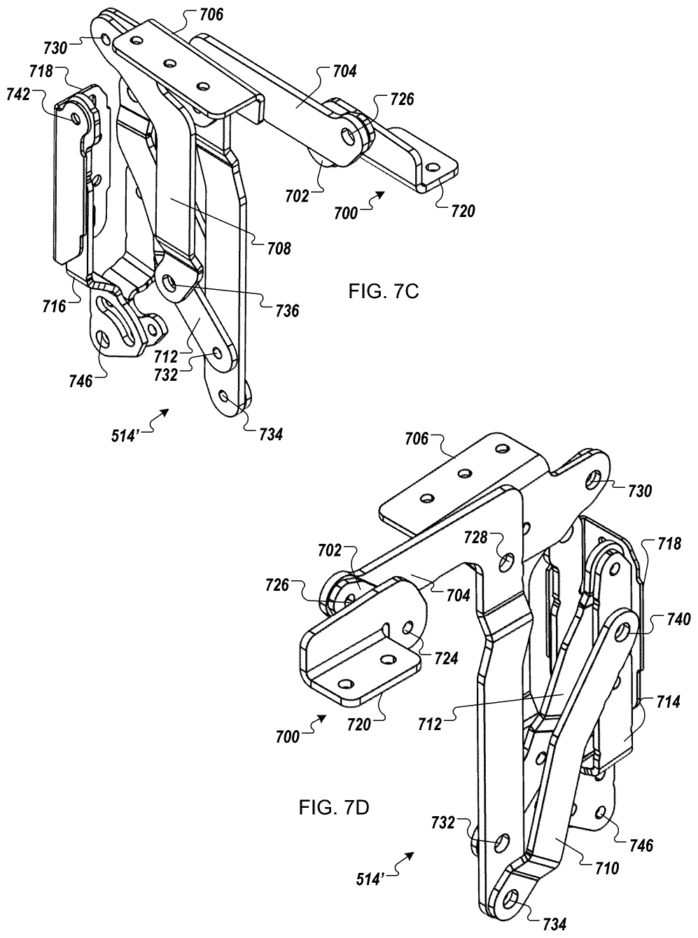

In general, the linkage mechanisms 514, e.g., linkage mechanism 514′ and linkage mechanism 514″, are substantially the same, e.g., have the same components and movement, and are mirror symmetric, e.g., mirror symmetry through the y-z plane. Referring to FIGS. 7A and 7B, perspective views of linkage mechanism 514′ are shown though it is to be understood that the elements and motions described with respect to linkage mechanism 514′ are included in linkage mechanism 514″. The linkage mechanisms 514 can be replaced while the reclining seating assembly 500 is installed on a theater riser without disassembling any other part of the recliner 50. For example, one or more fasteners attaching the linkage mechanism 514 to the base frame 502 and seat frame 504 can all be accessed from the top with the seat flipped up. The footrest board can be removed from the linkage mechanism 514 prior to the linkage mechanism 514 being detached from the seat frame 504 in the reclined position, or the footrest board can be removed from the linkage mechanism 514 after removing the linkage mechanism 514 from the seat frame 504 and base frame 502. Fasteners for all sub-assemblies can be accessible without removing the base frame 502 from the riser, and with the chair arms still attached to the base frame 502. The linkage geometry of the linkage mechanisms 514 maintains the ottoman 58 tight to the riser in the closed position. The linkage geometry of the linkage mechanisms 514 facilitates quicker movement of the ottoman 58 into the reclined position enabling earlier support of an occupant's legs as they are lifted from the floor as the seat frame 504 rises.

The linkage mechanism 514′ includes a base plate 700 which is affixed to the base frame 502. The base plate 700 provides a rigid base from which the extension motions of the linkage mechanisms 514′ pivot. In some embodiments, the base plate 700 is affixed to the base frame 502, or to the upper riser, or both the upper riser and base frame 502. The base plate 700 includes a base attachment plate 720 that connects to the base frame 502.

A linking arm 702 connects the base plate 700 to the corner arm 704 through two pivot connections 724 and 726. In general, the pivot connections of the linkage mechanisms 514 are the same as rotary connections of the linkage mechanisms 114 above.

The corner arm 704 is generally ‘L’ shaped to facilitate the linkage bending around the front bracket 524 of the base frame 502. The corner arm 704 is connected to the seat plate 706 via pivot connection 728. The seat plate 706 is fixedly connected to the seat frame 504 such that motion of the seat frame 504 is translated into motion of the linkage mechanisms 514 by moving the relative positions of the seat plate 706 and base plate 700 as described above.

The seat plate 706 is connected to linking arm 708 via pivot connection 730. The linking arm 708 is connected to linking arm 712 via pivot connection 736. The corner arm 704 is connected to the linking arm 710 and the linking arm 712 via pivot connection 734 and pivot connection 732 respectively. The linking arm 708, corner arm 704, linking arm 710, and linking arm 712 form a four-arm linkage assembly which control the extension and angle of the ottoman plate 718.

Rotation of the corner arm 704 upward urges linking arm 712 and linking arm 710 upward. The linking arm 708 urges the linking arm 712 outward by pressing against the pivot connection 736. As the linking arm 710 rotates around the pivot connection 734 and the pivot connection 744, the linking arm 714 and support arm 716 extend forward. The linking arm 712 rotates around pivot connection 740 thereby extending the linking arm 714 forward and adjusting the angle of the ottoman plate 718.

The linking arm 712 and the linking arm 710 are connected to linking arm 714 at pivot connection 740 and pivot connection 744 respectively. An ottoman plate 718 is connected to support arm 716 at pivot connection 742 which is connected to linking arm 714 at pivot connection 746. FIGS. 7C and 7D show perspective views of the linkage mechanism 514′ in the collapsed state of FIG. 6B.

The reclining seating assembly 500 is configured such that the seat may be raised from the riser. The seat of the reclining assembly 500 may be rotated around an axis near the front of the seat frame 504 to provide access to the reclining assembly 500 when installed to a riser. The seat being rotatable reduces labor and time invested for installation, cleaning, or maintenance.

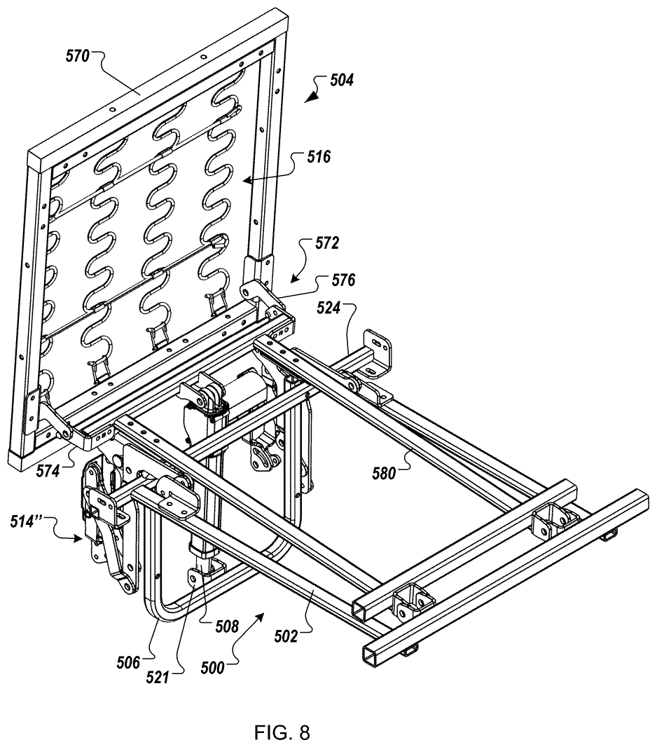

A perspective view of the low-profile recliner assembly 500 with a cushion support frame 570 rotated upwardly from a lower seat frame 580 is shown in FIG. 8. The lower seat frame 580 is pivotally connected to cushion support frame 570 by hinges 572 which are secured to the lower seat frame 580 and the cushion support frame 570. The hinges 572 include hinge 574 and hinge 576 connected to the outer surfaces of the seat frame 504 respectively. The hinges 572 attach to an underside surface of the cushion support frame 570 so that the cushion support frame 570 pivots upward and forward from the lower seat frame 580.

In some examples, the hinges 572 having a stop such that the seat frame 504 can be halted in an open position, e.g., as the lifting frame 570 opens upward and forward from the lower seat frame 580, e.g., when the lifting frame 570 is about 90 degrees from the lower seat frame 580. In some examples, the hinges 572 attach such that the pivoting points of the hinges 572 are within an outer dimension of, e.g., inside, the lifting frame 570, the lower seat frame 580, or both. The hinges 572 can be attached to the inside of the seat frame 504 away from upholstery around the seat frame 504 to keep the hinges 572 from contacting the upholstery when moved.

In some embodiments, the front bracket 924 of the low profile recliner assembly 900 is arranged in front of a riser on which the low profile recliner assembly 900 is installed. Such a configuration increases the ease and speed at which the area below the seat frame 904 may be cleaned.

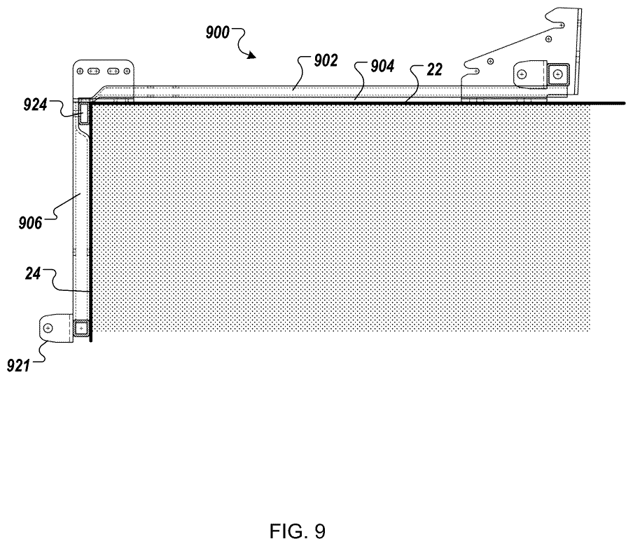

A base frame 902 and a support frame 906 of an easy-to-clean recliner assembly 900 are shown in FIG. 9. The base frame 902 is shown on the upper riser 22. The support frame 906 is shown abutting the riser face 24. The front bracket 924 of the recliner assembly 900 is arranged to be below the lower plane of the base frame 902. The support frame 906 includes an indent in an end distal from the mounting bracket 921. The indent in the support frame 906 connects to the base frame 902 such that the front bracket 924 is contacting the riser face 24 behind the support frame 906. This arrangement allows access to the top surface of the upper riser 22 from the front of the easy-to-clean recliner assembly 900.

While this specification contains various details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

What is claimed is:

1. A reclining seating assembly, comprising:
a seat frame;
a base frame configured to connect to the seat frame by a hinge;
a support frame configured to connect to the base frame;
an actuator configured to connect to the support frame and the seat frame; and
a pair of linkage mechanisms each having a base plate and a seat plate configured to connect by a plurality of linking arms, the base plate of each linkage mechanism configured to connect to the base frame and the seat plate of each linkage mechanism configured to connect to the seat frame,
wherein the reclining seating assembly is configured to move between a reclined position and a seated position by extension or contraction of the actuator.

2. The assembly of claim 1, wherein extending the actuator causes the reclining seat assembly to enter the reclined position in which the linkage mechanism is caused to extend and an angle formed between the seat frame and the base frame increases.

3. The assembly of claim 2, wherein contracting the actuator causes the reclining seat assembly to enter the seated position in which the linkage mechanism contracts and the angle formed between the seat frame and the base frame decreases.

4. The assembly of claim 2, wherein, when the reclining seating assembly is in the reclined position, the linkage mechanism is fully extended.

5. The assembly of claim 3, wherein, when the reclining seating assembly is in the seated position, the linkage mechanism is fully contracted.

6. The assembly of claim 5, wherein, when the linkage mechanism is fully contracted, the linkage mechanism has a depth of less than or equal to 3 inches.

7. The assembly of claim 5, wherein, when the reclining seating assembly is in the contracted position, a height of the seat frame and the base frame is less than or equal to 3 inches.

8. The assembly of claim 1, wherein the actuator extends in a direction that is substantially perpendicular to a plane of the base frame.

9. The assembly of claim 1, wherein the actuator is configured to pivotally connect to a mounting bracket of the base frame and configured to pivotally connect to a mounting bracket of the support frame.

10. The assembly of claim 1, wherein the base frame and the support frame are configured to affix to two perpendicular faces of a riser on which the reclining seat assembly is installed.

11. The assembly of claim 1, wherein the linkage mechanism comprises a seat plate fixedly coupled to the seat frame.

12. The assembly of claim 1, wherein the actuator is an electric actuator or a pneumatic actuator.

13. The assembly of claim 1, wherein there is only one actuator.

14. The assembly of claim 2, comprising a backrest bracket coupled to the seat frame at the hinge, and a chair back fixedly coupled to the backrest bracket, such that the chair back moves with the seat frame.

15. The assembly of claim 14, comprising an ottoman connected to an ottoman plate of the linkage mechanism, the ottoman plate at an opposing end of the linkage mechanism from the base plate, and a seat attached to the seat frame.

16. The assembly of claim 15, comprising arms adjacent the reclining seat assembly, and a base frame and support frame fixedly attached to a commercial theater riser.

17. The assembly of claim 15, the base frame and support frame fixedly attached to a recreational vehicle seating riser.

18. The reclining seating assembly of claim 1, comprising a backrest frame connected to the base frame, the backrest frame comprising:
a lower frame pivotally connected to a headrest frame, and
a second actuator configured to connect to the lower frame and the headrest frame, wherein the backrest frame is configured to move between a first position and a second position of the headrest frame by extension or contraction of the second actuator.

19. The reclining seating assembly of claim 18, wherein the first position and the second position are rotated by an angle less than 20°.

20. The reclining seating assembly of claim 18, comprising a pair of brackets connecting the backrest frame to the seat frame, the pair of brackets having a sequence of openings arranged to align with an opening of the lower frame such that the lower frame can be positioned in one position of a plurality of positions.

21. The reclining seating assembly of claim 1, wherein the seat frame is a folding seat frame comprising a cushion support frame pivotally connected to a lower seat frame.

22. The reclining seating assembly of claim 21, wherein the folding seat frame is configured such that the cushion support frame pivotally connects to the lower seat frame such that the cushion support frame rotates at least partially around an axis parallel with a front edge of the cushion support frame and a front edge of the lower seat frame.

23. The reclining seating assembly of claim 22, wherein the seat frame comprises hinges pivotally connecting the cushion support frame to the lower seat frame.

24. The reclining seating assembly of claim 23, wherein the hinges are configured to hinge inward of outer dimensions of the seat frame and outer dimensions of the cushion support frame.

25. The reclining seating assembly of claim 1, wherein the seat frame is configured to form an angle with respect to the base frame when the reclining seating assembly is in the seated position.

26. The reclining seating assembly of claim 25, wherein the angle is less than 10°.

27. The reclining seating assembly of claim 1, wherein the base frame, the seat frame, or the support frame include tubular metal components, or angled metal components.

28. The reclining seating assembly of claim 27, wherein the tubular metal components, or angled metal components, are welded to form the base frame, the seat frame, or the support frame.

29. A reclining seat, comprising:
a seat frame;
a base frame configured to connect to the seat frame by a hinge;
a backrest configured to fixedly attach to the seat frame;
a support frame configured to connect to the base frame;
an actuator configured to pivotally connect to the support frame and the seat frame;
an ottoman board;
two chair arms, configured to be arranged on opposing sides of the base frame;
a pair of linkage mechanisms each having a base plate, a seat plate, and an ottoman plate configured to connect by a plurality of linking arms, the base plate of each linkage mechanism configured to connect to the base frame, the seat plate of each linkage mechanism configured to connect to the seat frame, and the ottoman plate configured to connect to the ottoman board,
wherein the reclining seat is configured to move between a reclined position and a seated position by extension or contraction of the actuator;
a plurality of cushions configured to be installed to at least one of the seat frame, the ottoman board, or the back rest;
a user interface, configured to be installed in one of the chair arms; and
a controller in electronic communication with the user interface and the actuator and configured to receive commands from the user interface and control the actuator in response to the received commands.
